(19) United States
(12) Patent Application Publication
(10) Pub. No.: US 2018/0292423 A1
(43) Pub. Date: Oct. 11, 2018

(54) METHOD AND INSTRUMENT FOR PROCESSING SAMPLE CARRIER CARDS

(71) Applicant: WALLAC OY, Turku (FI)

(72) Inventors: Mika Olavi ROUTAMAA, Lieto (FI); Timo SALMINEN, Turku (FI)

(21) Appl. No.: 15/574,566

(22) PCT Filed: May 12, 2016
(86) PCT No.: PCT/FI2016/050314

§ 371 Date: Nov. 16, 2017

(30) Foreign Application Priority Data
May 20, 2015 (FI) 20155366

(51) Int. Cl. G01N 35/00; G01N 1/28; B01L 9/00; G01N 35/02

(52) U.S. Cl. CPC G01N 35/00029; G01N 1/286; B01L 9/52; G01N 2035/0441; G01N 2001/2873; G01N 2035/00049; G01N 2035/00752; G01N 35/025

(57) ABSTRACT

An instrument for processing sample carrier cards is described. Each sample carrier card contains impregnated sample material, e.g. blood. The instrument includes actuators capable of doing actions related to the sample carrier cards when the sample carrier cards are located on operating areas of the actuators. The actions may include e.g. optical imaging, cutting off sample pieces from a sample carrier card, and reading machine-readable information from a sample carrier card. The instrument includes a rotatably supported carousel element for carrying the sample carrier cards so that separate ones of the sample carrier cards are on separate ones of the operating areas and the sample carrier cards are movable between the operating areas by rotating the carousel element. Thus, the actions can be carried out in parallel and therefore the sample carrier cards can be processed in a pipelined manner enabling a higher processing rate.

### FIELD OF THE DISCLOSURE

The disclosure relates to a method and to an instrument for processing sample carrier cards each containing impregnated sample material, e.g. dried blood. Furthermore, the disclosure relates to a body module for an instrument for processing sample carrier cards. The body module can be used as a platform with the aid of which different instruments for processing sample carrier cards can be constructed.

### BACKGROUND

A conventional practice is to impregnate one or more drops of fluid to be examined onto a sample carrier card, then dry the sample carrier card impregnated with the fluid, and then send the sample carrier card to a laboratory for examination. The fluid to be examined can be for example blood of a newborn baby and the sample carrier card may comprise for example a sheet of filter paper or some other suitable porous material which is able to absorb the fluid to be examined. In the laboratory, one or more regions containing the fluid to be examined, i.e. one or more sample pieces, are cut off from the sample carrier card and the one or more sample pieces are conveyed, for further analysis, to one or more sample wells of e.g. a microtitration plate or some other sample well element. Each sample piece can be cut off from the sample carrier card for example with a punch and a die provided with a guide channel for supporting the punch, where the punch is arranged to cut off the sample piece with a single stroke through the sample carrier card. It is also possible to use a cutting appliance capable of producing a localized, point-form cut on the sample carrier card and to move the point-form cutting impact produced by the cutting appliance along the outer periphery of each sample piece so as to detach the sample piece from the sample carrier card.

In addition to the cutting off the sample pieces from the sample carrier cards, there are typically also other actions to be carried out concerning the sample carrier cards. The other actions may comprise for example: producing an image of at least a portion of a sample carrier card, carrying out an image analyzing algorithm for finding, from the produced image, one or more regions distinguished from their surroundings so as to determine locations of one or more sample pieces to be cut off, and/or reading machine-readable information from a sample carrier card. Laboratory costs related to processing a given set of sample carrier cards are at least partly dependent on the time needed for doing the required actions concerning the sample carrier cards under consideration. Therefore, there is an endeavor to manage the performance of the above-mentioned actions so that the sample carrier cards are processed at a rate that is sufficient for keeping the laboratory costs at an acceptable level.

### SUMMARY

The following presents a simplified summary in order to provide a basic understanding of some aspects of various exemplifying embodiments. The summary is not an extensive overview of the disclosure of this document. It is neither intended to identify key or critical elements of exemplifying embodiments nor to delineate the protection scope. The following summary merely presents some concepts in a simplified form as a prelude to a more detailed description of exemplifying embodiments.

In accordance with the disclosure, there is provided a new instrument for processing sample carrier cards each containing impregnated sample material, e.g. dried blood. The instrument comprises:
a platform structure,
actuators placed on the platform structure and capable of doing actions related to the sample carrier cards when the sample carrier cards are located on operating areas related to the actuators, and
a carousel element rotatably supported with respect to the platform structure and suitable for carrying the sample carrier cards so that separate ones of the sample carrier cards are on separate ones of the operating areas and the sample carrier cards are movable between the operating areas by rotating the carousel element.

The above-mentioned actions may comprise, for example but not necessarily, producing an image of at least a portion of a sample carrier card, cutting off one or more sample pieces from a sample carrier card, moving a sample carrier card from storage of unprocessed sample carrier cards to the carousel element, moving a sample carrier card from the carousel element to storage of processed sample carrier cards, and/or reading machine-readable information from a sample carrier card.

As separate ones of the sample carrier cards are on separate ones of the operating areas related to the actuators and the sample carrier cards are movable between the operating areas by rotating the carousel element, the actions related to the sample carrier cards can be carried out in parallel and therefore the sample carrier cards can be processed in a pipelined manner enabling a higher processing rate than in a case where only one sample carrier card is being processed at a time.

In accordance with the disclosure, there is provided also a new body module for an instrument for processing sample carrier cards. The body module comprises:
a platform structure for mechanically supporting actuators capable of doing actions related to the sample carrier cards when the actuators are placed on the platform structure and the sample carrier cards are located on operating areas related to the actuators, and
a carousel element rotatably supported with respect to the platform structure and suitable for carrying the sample carrier cards so that separate ones of the sample carrier cards are on separate ones of the operating areas and the sample carrier cards are movable between the operating areas by rotating the carousel element.

The above-mentioned body module can be used as a platform with the aid of which different instruments for processing sample carrier cards can be constructed by using different actuators.

In accordance with the disclosure, there is provided also a new method for processing sample carrier cards each containing impregnated sample material. The method comprises:
carrying the sample carrier cards with a rotatably supported carousel element so that separate ones of the sample carrier cards are on separate ones of operating areas related to actions to be carried out concerning the sample carrier cards,
doing the actions, and
moving the sample carrier cards between the operating areas by rotating the carousel element.

A number of exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments and their advantages are explained in greater detail below in the sense of examples and with reference to the accompanying drawings, in which:

FIG. 1a illustrates an instrument according to an exemplifying and non-limiting embodiment for processing sample carrier cards,

FIG. 1b illustrates one of the sample carrier cards that can be a sample carrier card according to the prior art, and

FIG. 2 shows a flowchart of a method according to an exemplifying and non-limiting embodiment for processing sample carrier cards.

### DESCRIPTION OF EXEMPLIFYING AND NON-LIMITING EMBODIMENTS

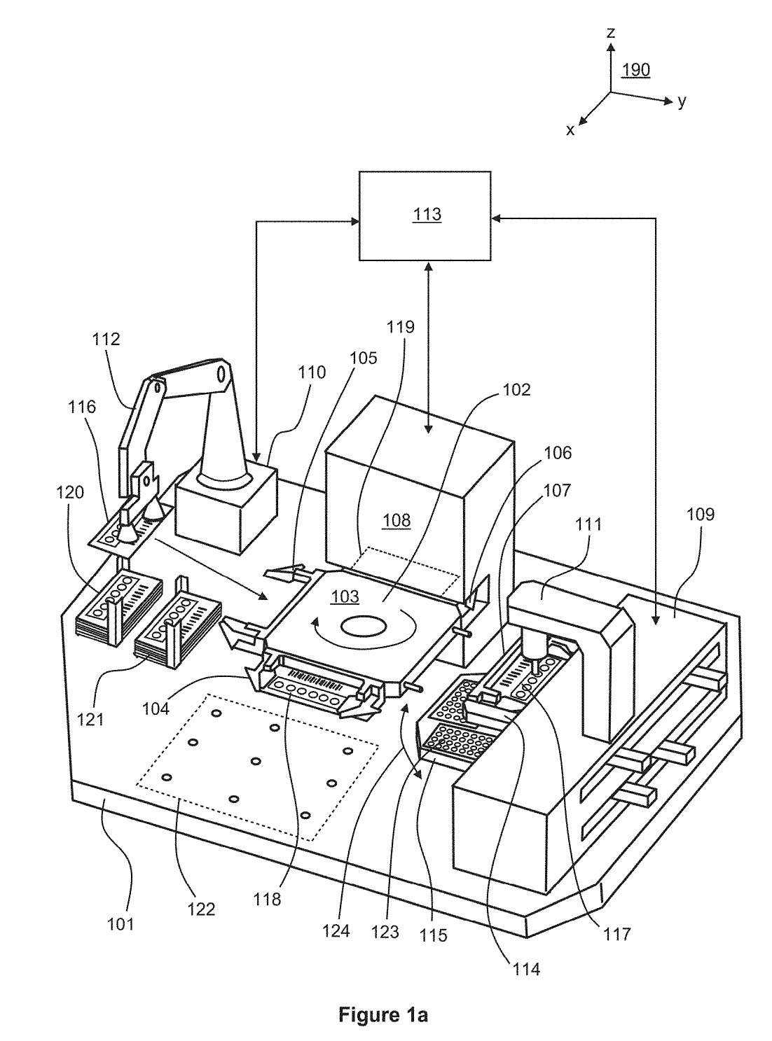

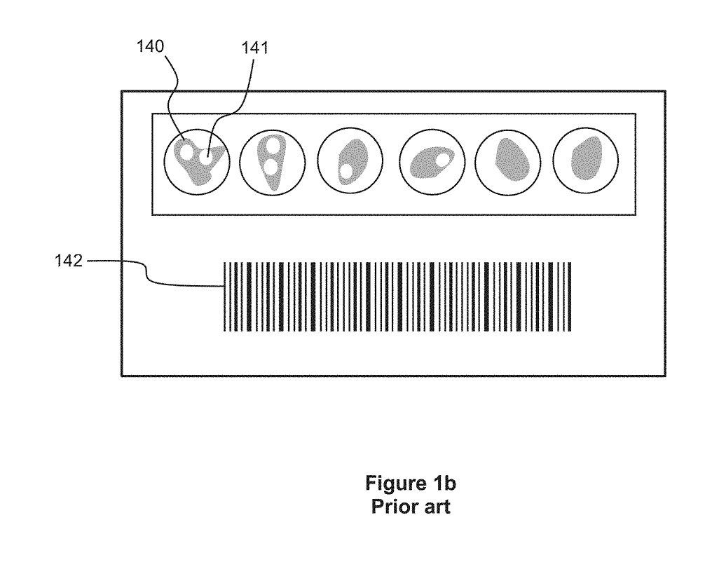

FIG. 1a illustrates an instrument according to an exemplifying and non-limiting embodiment for processing sample carrier cards. Each sample carrier card may comprise for example a sheet of filter paper or some other suitable porous material which is able to absorb sample material that can be e.g. blood of a newborn baby. The sample carrier cards can be according to the prior art. FIG. 1b shows one of the sample carrier cards. Blotches of the sample carrier card shown in FIG. 1b are regions into which the sample material has been impregnated. In FIG. 1b, one of the blotches is denoted with a reference number 140. One or more sample pieces are cut off from the above-mentioned regions into which the sample material has been impregnated. After cutting, the detached sample pieces are conveyed for further analysis. The sample carrier card shown in FIG. 1b has holes on places from which the sample pieces have been cut off. In FIG. 1b, one of the holes is denoted with a reference number 141. The sample carrier card may comprise a machine-readable identifier section 142 that may contain, for example, information about the donor of the sample material, information about the time and place of taking the sample, and/or other appropriate information. In this exemplifying case, the machine-readable identifier section 142 comprises a barcode but many other ways of presenting machine readable data are also possible instead of or in addition to the barcode.

The instrument for processing the sample carrier cards comprises a platform structure 101 which constitutes a mechanical support for other elements of the instrument. In this exemplifying case, the platform structure 101 is flat plate of suitable material, e.g. aluminum, but various other mechanical structures are also possible.

For example, the platform structure may comprise bars which are attached to each other so that the other elements of the instrument can be mechanically supported. The instrument comprises actuators 108, 109, and 110 placed on the platform structure 101 and capable of doing actions related to the sample carrier cards when the sample carrier cards are located on operating areas related to the actuators. The instrument comprises a carousel element 102 that is rotatably supported with respect to the platform structure 101 so that the axis of rotation is parallel with the z-axis of a coordinate system 190. The carousel element 102 is suitable for carrying the sample carrier cards so that separate ones of the sample carrier cards are on separate ones of the operating areas of the actuators and the sample carrier cards are movable between the operating areas by rotating the carousel element. The instrument comprises a processor system 113 for controlling the operation of the actuators 108, 109, and 110 and the operation of the carousel element 102. The processor system 113 can be implemented with one or more processor circuits, each of which can be a programmable processor circuit provided with appropriate software, a dedicated hardware processor such as for example an application specific integrated circuit “ASIC”, or a configurable hardware processor such as for example a field programmable gate array “FPGA”.

The platform structure 101 and the carousel element 102 constitute a body module with the aid of which different instruments can be constructed by furnishing the body module with different actuators. The possibility to construct different instruments is manifested e.g. by the fact that the exemplifying and non-limiting instrument shown in FIG. 1a comprises a free place 122 for an additional actuator. In FIG. 1a, the free place 122 is depicted with dashed lines.

In the exemplifying and non-limiting instrument illustrated in FIG. 1a, the actuator 108 comprises an optical imaging appliance for producing an image of at least a portion of a sample carrier card that is located on the operating area related to the actuator 108. In FIG. 1a, the above-mentioned sample carrier card is depicted with dashed lines and denoted with a reference number 119. The actuator 108 may further comprise for example a reader for reading machine-readable information from the sample carrier card 119. The actuator 109 comprises a cutting appliance 111 for cutting off one or more sample pieces from a sample carrier card that is located on the operating area related to the actuator 109. In the exemplifying situation shown in FIG. 1a, the cutting appliance 111 is arranged to cut off sample pieces from a sample carrier card 117. The cutting appliance 111 may comprise for example a punch and a die provided with a guide channel for supporting the punch, where the punch is arranged to cut off the sample piece with a single stroke through the sample carrier card. It is also possible to use a cutting appliance capable of producing a localized, point-form cut on the sample carrier card and to move the point-form cutting impact produced by the cutting appliance along the outer periphery of each sample piece so as to detach the sample piece from the sample carrier card. In this case, the cutting appliance 111 can be, for example, a laser beam cutter or a liquid jet cutter. The actuator 110 comprises a card transfer appliance 112 for moving the sample carrier cards from storage 120 of unprocessed sample carrier cards to the carousel element 102 and for moving the sample carrier cards from the carousel element 102 to storage 121 of processed sample carrier cards. In the exemplifying situation shown in FIG. 1a, the card transfer appliance 112 is moving a sample carrier card 116 from the storage 120 of unprocessed sample carrier cards to the carousel element 102.

In the exemplifying and non-limiting instrument illustrated in FIG. 1a, the carousel element 102 comprises a rotatably supported body section 103 and frame sections 104, 105, 106, and 107 for carrying the sample carrier cards so that separate ones of the sample carrier cards are on separate ones of the frame sections. The frame sections are detachably attachable to the body section 103. In the exemplifying situation shown in FIG. 1a, the frame sections 104, 105, and 106 are attached to the body section 103 and the frame section 107 has been detached from the body section. Only a minor part of the frame section 106 is visible in FIG. 1a. In the exemplifying situation shown in FIG. 1a, the frame section 104 carries a sample carrier card 118, the frame section 105 is empty, the frame section 106 carries the sample carrier card 119, and the frame section 107 carries the sample carrier card 117.

The frame sections 104-107 which are detachably attachable to the body section 103 make it possible that an actuator detaches a frame section from the body section, then carries out the actions related to the sample carrier card carried by the detached frame section, and finally returns the frame section back to the body section. In the exemplifying and non-limiting instrument illustrated in FIG. 1a, the actuator 109 comprises a first positioning system 114 configured to detach, from the body section 103, such one of the frame sections that is located on the operating area of the actuator 109. In the exemplifying situation shown in FIG. 1a, the detached frame section is the frame section 107. The first positioning system 114 is capable of moving the detached frame section 107 in the xy-plane of the coordinate system 190, i.e. in the positive and negative x-directions and in the positive and negative y-directions. The first positioning system 114 is configured move the detached frame section 107 with respect to the cutting appliance 111 so that the cutting appliance is able to cut off desired one or more sample pieces from the sample carrier card 117 carried by the detached frame section 107. The first positioning system 114 is configured attach the detached frame section 107 back to the body section 113 after the one or more sample pieces have been cut off from the sample carrier card 117. It is, however, worth noting that the actuators of an instrument for processing sample carrier cards can be such that the actuators are capable of doing the actions related to the sample carrier cards when the sample carrier cards are carried by the carousel element. In this case, the frame sections for carrying the sample carrier cards can be fixed, i.e. non-detachable, parts of the carousel element.

In the exemplifying and non-limiting instrument illustrated in FIG. 1a, the actuator 109 further comprises a support element 115 for supporting one or more sample well elements so that an appropriate sample well element is able to receive the one or more sample pieces cut off from the sample carrier card 117. The actuator 109 comprises a second positioning system for positioning the support element 115 so that the one or more sample pieces are received at desired one or more sample wells of the appropriate sample well element. In FIG. 1a, one of the sample well elements is denoted with a reference number 123. The second positioning system is capable of moving the support element 115 in the xy-plane of the coordinate system 190, i.e. in the positive and negative x-directions and in the positive and negative y-directions. The second positioning system is advantageously configured to move support element 115 smoothly so that the movement of the support element 115 is free from abrupt stops and starts during a time period when the one or more sample pieces are received at the appropriate sample wells. Abrupt stops and starts are undesirable because the related accelerations and decelerations would shake the sample well element and thereby cause a risk that one or more of the detached sample pieces bounce to wrong sample wells. Furthermore, the time needed for cutting off the sample pieces can be smaller when the time is not wasted for numerous stops and starts of the movement of the sample well element. In an instrument according to an exemplifying and non-limiting embodiment, the second positioning system is configured to not only move the support element 115 in the positive and negative x-directions and in the positive and negative y-directions but also to rotate the support element 115 around a geometric line substantially parallel with the z-axis of the coordinate system 190. In FIG. 1a, the rotation is illustrated with an arched two-headed arrow 124. Because of the possibility to rotate support element 115, the movement room needed for the support element 115 is smaller than in a case where only translational movements in the positive and negative x-directions and in the positive and negative y-directions are possible.

In an instrument according to an exemplifying and non-limiting embodiment, the processor system 113 is configured to run an image analyzing algorithm for finding, from the image produced by the actuator 108, one or more regions which are distinguished from theirs surroundings with respect to e.g. color and/or brightness in order to determine the locations of such one or more regions of the sample carrier 119 which have been impregnated with the sample material. The processor system 113 is configured to determine the location/locations of the one or more sample pieces to be cut off so that the one or more sample pieces belong as well as possible to the above-mentioned one or more regions which have been impregnated with the sample material. The processor system 113 can be, for example, configured to compare brightness values of pixels of the image to a threshold value, wherein the result of the comparison determines whether or not an individual pixel belongs to a region which is deemed to be distinguished from its surroundings. In order to make the determination more independent of prevailing lightning conditions, the processor can be further arranged to determine the above-mentioned threshold value on the basis of an average or median brightness value of all pixels of the image or of a certain part of the image. The processor system 113 is configured to control the carousel element 102 to move the sample carrier card 119 from the operating area of the actuator 108 to the operating area of the actuator 109 that comprises the cutting appliance 111. The processor system 113 is configured to control, at least partly on the basis of the result of the image analyzing algorithm, the cutting appliance 111, the first positioning system 114 for positioning the sample carrier card under the cutting process, and the second positioning system for positioning the support element 115 which carries the sample well element. In addition to the result of the image analyzing algorithm, the cutting appliance, the first positioning system, and the second positioning system can be controlled on the basis of signals received from a user interface of the instrument, i.e. on the basis of actions of the user.

The processor system 113 is advantageously configured to produce, on the basis of the result of the image analyzing algorithm, coordinate data which indicates the location of each of the one or more sample pieces to be cut off from a sample carrier card with respect to a pre-determined point of the frame section that carries the sample carrier card under consideration. The processor system can be configured to control the cutting appliance 111 to cut off the one or more sample pieces on the basis of (i) the above-mentioned coordinate data and (ii) the position of the frame section with respect to the actuator comprising the cutting appliance when the frame section is on the operating area related to the actuator comprising the cutting appliance. Thus, the information defining the locations of the sample pieces to be cut off from a sample carrier card can be transferred between the actuators so that the locations are defined with respect to the frame section which carries the sample carrier card and which in turn can be accurately positioned at each actuator. The frame sections can be provided for example with locating pins and/or other means which unambiguously determine the location of each frame section with respect to an actuator under consideration.

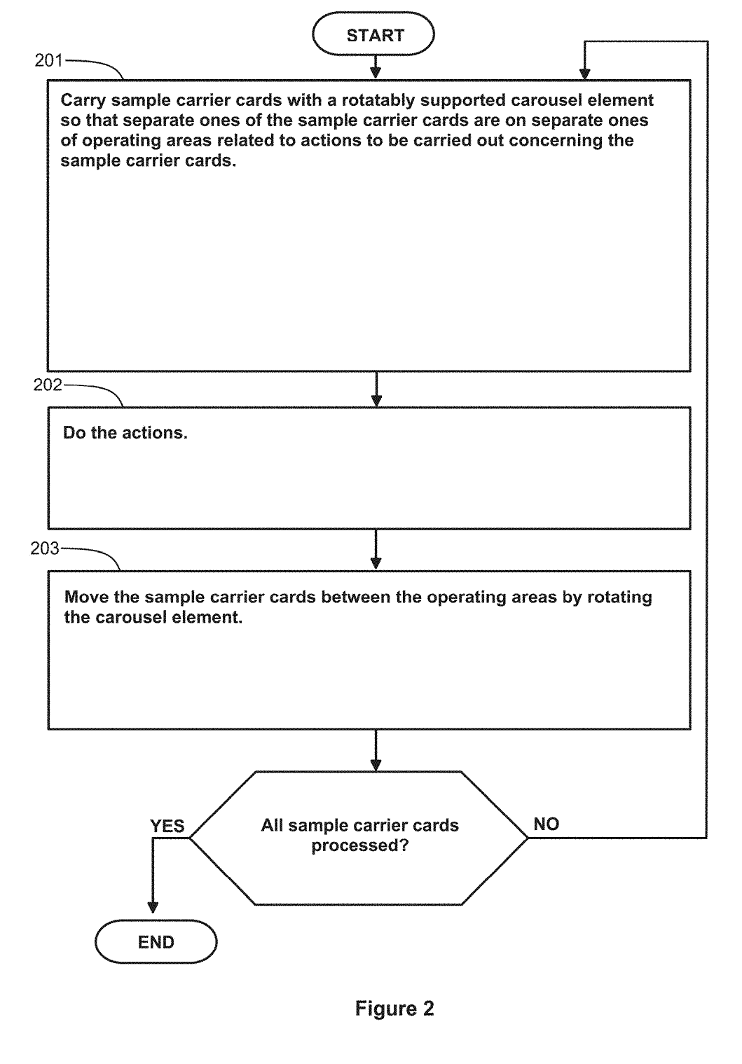

FIG. 2 shows a flowchart of a method according to an exemplifying and non-limiting embodiment for processing sample carrier cards each containing impregnated sample material, e.g. dried blood. The method comprises the following actions:
action 201: carrying the sample carrier cards with a rotatably supported carousel element so that separate ones of the sample carrier cards are on separate ones of operating areas related to actions to be carried out concerning the sample carrier cards,
action 202: doing the actions, and
action 203: moving the sample carrier cards between the operating areas by rotating the carousel element.

In a method according to an exemplifying and non-limiting embodiment, one of the actions comprises optical imaging for producing an image of at least a portion of such one of the sample carrier cards that is located on the operating area related to the optical imaging.

In a method according to an exemplifying and non-limiting embodiment, one of the actions comprises cutting off one or more sample pieces from such one of the sample carrier cards that is located on the operating area related to the cutting.

In a method according to an exemplifying and non-limiting embodiment, one of the actions comprises moving one of the sample carrier cards from storage of unprocessed sample carrier cards to the carousel element.

In a method according to an exemplifying and non-limiting embodiment, one of the actions comprises moving one of the sample carrier cards from the carousel element to storage of processed sample carrier cards.

In a method according to an exemplifying and non-limiting embodiment, one of the actions comprises reading machine-readable information from such one of the sample carrier cards that is located on the operating area related to the reading.

A method according to an exemplifying and non-limiting embodiment comprises:
optical imaging for producing an image of at least a portion of such one of the sample carrier cards that is located on the operating area related to the optical imaging,
running an image analyzing algorithm for finding, from the produced image, one or more regions distinguished from their surroundings so as to determine locations of one or more sample pieces to be cut off from the one of the sample carrier cards located on the operating area related to the optical imaging,
rotating the carousel element so as to move the one of the sample carrier cards from the operating area related to the optical imaging to such one of the operating areas that is related to the cutting off the one or more sample pieces, and
controlling, at least partly on the basis of the result of the image analyzing algorithm, the cutting off the one or more sample pieces.

In a method according to an exemplifying and non-limiting embodiment, the separate ones of the sample carrier cards are carried with separate ones of frame sections of the carousel element. The frame sections are detachably attachable to a rotatably supported body section of the carousel element.

A method according to an exemplifying and non-limiting embodiment comprises:
detaching, from the body section, such one of the frame sections that is located on such one of the operating areas that is related to cutting off one or more sample pieces from such one of the sample carrier cards that is located on the one of the operating areas related to the cutting,
moving the detached frame section with respect to a cutting appliance so as to enable the cutting appliance to cut off the one or more sample pieces from the sample carrier card carried by the detached frame section, and
attaching the detached frame section back to the body section after the one or more sample pieces have been cut off.

A method according to an exemplifying and non-limiting embodiment comprises:
producing, on the basis of the result of the image analyzing algorithm, coordinate data which indicates the location of each of the one or more sample pieces to be cut off from the sample carrier card with respect to a pre-determined point of the frame section that carries the sample carrier card under consideration, and
controlling the cutting off the one or more sample pieces on the basis of: (i) the coordinate data and (ii) a position of the frame section with respect to an actuator for cutting off the one or more sample pieces when the frame section is on the operating area related to the cutting off the one or more sample pieces.

A method according to an exemplifying and non-limiting embodiment comprises moving a sample well element so that the one or more sample pieces are received at pre-determined one or more sample wells of the sample well element.

In a method according to an exemplifying and non-limiting embodiment, the sample well element is moved so that the movement of the sample well element is free from stops during a time period when the one or more sample pieces are received at the pre-determined one or more of sample wells of the sample well element.

In a method according to an exemplifying and non-limiting embodiment, the moving the sample well element comprises translating the sample well element in a geometric plane substantially perpendicular to the rotation axis of the carousel element and rotating the sample well element around a geometric line substantially parallel with the rotation axis of the carousel element.

The specific examples provided in the description given above should not be construed as limiting. Therefore, the protection scope is not limited merely to the exemplifying embodiments described above. Lists and groups of examples presented above are not exhaustive unless otherwise explicitly stated.

1-27. (canceled)

28. A body module for an instrument for processing sample carrier cards, the body module comprising:
a platform structure for mechanically supporting actuators capable of doing actions related to the sample carrier cards when the actuators are placed on the platform structure and the sample carrier cards are located on operating areas related to the actuators,
wherein the body module comprises a carousel element rotatably supported with respect to the platform structure and suitable for carrying the sample carrier cards so that separate ones of the sample carrier cards are on separate ones of the operating areas and the sample carrier cards are movable between the operating areas by rotating the carousel element.

29. A body module according to claim 28, wherein the carousel element comprises a rotatably supported body section and frame sections for carrying the sample carrier cards so that the separate ones of the sample carrier cards are on separate ones of the frame sections, the frame sections being detachably attachable to the body section.

30. An instrument for processing sample carrier cards each containing impregnated sample material, the instrument comprising:
a body module according to claim 28, and
actuators placed on the platform structure of the body module and capable of doing actions related to the sample carrier cards when the sample carrier cards are located on operating areas related to the actuators.

31. An instrument according to claim 30, wherein one of the actuators comprises an optical imaging appliance for producing an image of at least a portion of such one of the sample carrier cards that is located on the operating area related to the actuator comprising the optical imaging appliance.

32. An instrument according to claim 30, wherein one of the actuators comprises a cutting appliance for cutting off one or more sample pieces from such one of the sample carrier cards that is located on the operating area related to the actuator comprising the cutting appliance.

33. An instrument according to claim 30, wherein one of the actuators comprises a card transfer appliance for moving the sample carrier cards from storage of unprocessed sample carrier cards to the carousel element and for moving the sample carrier cards from the carousel element to storage of processed sample carrier cards.

34. An instrument according to claim 30, wherein one of the actuators comprises a reader for reading machine-readable information from such one of the sample carrier cards that is located on the operating area related to the actuator comprising the reader.

35. An instrument according to claim 31, wherein the instrument comprises a processor system configured to:
run an image analyzing algorithm for finding, from the produced image, one or more regions distinguished from their surroundings so as to determine locations of one or more sample pieces to be cut off from the one of the sample carrier cards located on the operating area related to the actuator comprising the optical imaging appliance,
control the carousel element to move the one of the sample carrier cards from the operating area related to the actuator comprising the optical imaging appliance to the operating area related to such one of the actuators that comprises a cutting appliance for cutting off the one or more sample pieces, and
control, at least partly on the basis of a result of the image analyzing algorithm, the cutting appliance to cut off the one or more sample pieces.

36. An instrument according to claim 35, wherein the carousel element comprises a rotatably supported body section and frame sections for carrying the sample carrier cards so that the separate ones of the sample carrier cards are on separate ones of the frame sections, the frame sections being detachably attachable to the body section, and wherein the processor system is configured to:
produce, on the basis of a result of the image analyzing algorithm, coordinate data which indicates the location of each of the one or more sample pieces to be cut off from the sample carrier card with respect to a pre-determined point of a particular one of the frame sections that carries the sample carrier card under consideration, and
control the cutting appliance to cut off the one or more sample pieces on the basis of: (i) the coordinate data and (ii) a position of the one of the frame sections with respect to the actuator comprising the cutting appliance when the one of the frame sections is on the operating area related to the actuator comprising the cutting appliance.

37. An instrument according to claim 32, wherein the carousel element comprises a rotatably supported body section and frame sections for carrying the sample carrier cards so that the separate ones of the sample carrier cards are on separate ones of the frame sections, the frame sections being detachably attachable to the body section, and wherein the actuator comprising the cutting appliance further comprises a first positioning system configured to:
detach from the body section such one of the frame sections that is located on the operating area related to the actuator comprising the cutting appliance,
move the detached frame section with respect to the cutting appliance so as to enable the cutting appliance to cut off the one or more sample pieces from the sample carrier card carried by the detached frame section, and
attach the detached frame section back to the body section after the one or more sample pieces have been cut off.

38. An instrument according to claim 32, wherein the actuator comprising the cutting appliance further comprises a support element for supporting a sample well element so that the sample well element is able to receive the one or more sample pieces cut off from the sample carrier card located on the operating area related to the actuator comprising the cutting appliance.

39. An instrument according to claim 38, wherein the actuator comprising the cutting appliance further comprises a second positioning system for positioning the support element so that the one or more sample pieces are received at pre-determined one or more sample wells of the sample well element.

40. An instrument according to claim 39, wherein the second positioning system is configured to move support element so that movement of the support element is free from stops during a time period when the one or more sample pieces are received at the pre-determined one or more sample wells of the sample well element.

41. An instrument according to claim 39, wherein the second positioning system is capable of translating the support element in a geometric plane substantially perpendicular to a rotation axis of the carousel element and rotating the support element around a geometric line substantially parallel with the rotation axis of the carousel element.

42. A method for processing sample carrier cards each containing impregnated sample material, the method comprising:
doing actions related to the sample carrier cards when the sample carrier cards are located on operating areas related to the actions,
carrying the sample carrier cards with a rotatably supported carousel element so that separate ones of the sample carrier cards are on separate ones of the operating areas, and
moving the sample carrier cards between the operating areas by rotating the carousel element.

43. A method according to claim 42, wherein the separate ones of the sample carrier cards are carried with separate ones of frame sections of the carousel element, the frame sections being detachably attachable to a rotatably supported body section of the carousel element.

44. A method according to claim 42, wherein one of the actions comprises optical imaging for producing an image of at least a portion of such one of the sample carrier cards that is located on the operating area related to the optical imaging.

45. A method according to claim 42, wherein one of the actions comprises cutting off one or more sample pieces from such one of the sample carrier cards that is located on the operating area related to the cutting.

46. A method according to claim 42, wherein one of the actions comprises moving one of the sample carrier cards from storage of unprocessed sample carrier cards to the carousel element.

47. A method according to claim 42, wherein one of the actions comprises moving one of the sample carrier cards from the carousel element to storage of processed sample carrier cards.

48. A method according to claim 42, wherein one of the actions comprises reading machine-readable information from such one of the sample carrier cards that is located on the operating area related to the reading.

49. A method according to claim 44, wherein the method comprises:
running an image analyzing algorithm for finding, from the produced image, one or more regions distinguished from their surroundings so as to determine locations of one or more sample pieces to be cut off from the one of the sample carrier cards located on the operating area related to the optical imaging,
rotating the carousel element so as to move the one of the sample carrier cards from the operating area related to the optical imaging to such one of the operating areas that is related to the cutting off the one or more sample pieces, and
controlling, at least partly on the basis of a result of the image analyzing algorithm, the cutting off the one or more sample pieces.

50. A method according to claim 49, wherein the separate ones of the sample carrier cards are carried with separate ones of frame sections of the carousel element and the frame sections are detachably attachable to a rotatably supported body section of the carousel element, and wherein the method comprises:
producing, on the basis of a result of the image analyzing algorithm, coordinate data which indicates the location of each of the one or more sample pieces to be cut off from the sample carrier card with respect to a pre-determined point of a particular one of the frame sections that carries the sample carrier card under consideration, and
controlling the cutting off the one or more sample pieces on the basis of: (i) the coordinate data and (ii) a position of the one of the frame sections with respect to an actuator for cutting off the one or more sample pieces when the one of the frame sections is on the operating area related to the cutting off the one or more sample pieces.

51. A method according to claim 43, wherein the method comprises:
detaching, from the body section, such one of the frame sections that is located on such one of the operating areas that is related to cutting off one or more sample pieces from such one of the sample carrier cards that is located on the one of the operating areas related to the cutting,
moving the detached frame section with respect to a cutting appliance so as to enable the cutting appliance to cut off the one or more sample pieces from the sample carrier card carried by the detached frame section, and
attaching the detached frame section back to the body section after the one or more sample pieces have been cut off.

52. A method according to claim 45, wherein the method comprises moving a sample well element so that the one or more sample pieces are received at pre-determined one or more sample wells of the sample well element.

53. A method according to claim 52, wherein the sample well element is moved so that movement of the sample well element is free from stops during a time period when the one or more sample pieces are received at the pre-determined one or more of sample wells of the sample well element.

54. A method according to claim 52, wherein the moving the sample well element comprises translating the sample well element in a geometric plane substantially perpendicular to a rotation axis of the carousel element and rotating the sample well element around a geometric line substantially parallel with the rotation axis of the carousel element.
